(19) United States
(12) Patent Application Publication
(10) Pub. No.: US 2024/0321250 A1
(43) Pub. Date: Sep. 26, 2024

(54) ELECTRONIC INSTRUMENT, ELECTRONIC KEYBOARD INSTRUMENT, AND ELECTRONIC APPARATUS

(71) Applicant: CASIO COMPUTER CO., LTD., Tokyo (JP)

(72) Inventors: Naoto IMAMURA, Tokyo (JP); Yuuki NAKAJIMA, Tokyo (JP); Shingo FUKUSHIMA, Tokyo (JP); Takumi YOSHIDA, Tokyo (JP); Masaru KONDO, Tokyo (JP)

(21) Appl. No.: 18/609,216

(22) Filed: Mar. 19, 2024

(30) Foreign Application Priority Data
Mar. 24, 2023 (JP) 2023-047953

(51) Int. Cl. G10H 1/34; G10H 1/00; H04R 1/02

(52) U.S. Cl. CPC G10H 1/344; G10H 1/0083; H04R 1/025; G10H 2220/221; G10H 2220/265

(57) ABSTRACT

An electronic instrument includes a substrate including a first area in which a connecting terminal is provided for connection with an external device and a second area which is larger than the first area, and a sheet metal including a contact configured to be electrically connected with the substrate in the second area of the substrate and including an opening provided in a position corresponding to a position where the connecting terminal is provided in the first area.

### CROSS-REFERENCE TO RELATED APPLICATION

This application is based upon and claims the benefit of priority under 35 USC 119 of Japanese Patent Application No. 2023-047953 filed on Mar. 24, 2023, the entire disclosure of which, including the specification, claims, drawings, and abstract, is incorporated herein by reference in its entirety.

### BACKGROUND

### Technical Field

The present disclosure relates to an electronic instrument, an electronic keyboard instrument, and an electronic apparatus.

### Description of the Related Art

There have conventionally been provided electronic instruments such as electronic keyboard instruments which include a connecting terminal for attachment of an external device such as a USB connector to which USB equipment is connected. For example, Japanese Unexamined Patent Application Publication No. 2011-13508 discloses an electronic keyboard instrument in which a USB connector is disposed on a panel provided between a top plate of an instrument case and a keyboard. In this electronic keyboard instrument, the USB connector is disposed in such a manner that an insertion port thereof is oriented to a front side.

### SUMMARY

According to a first aspect of the present disclosure, there is provided an electronic instrument including a substrate including a first area in which a connecting terminal is provided for connection with an external device and a second area which is larger than the first area, and a sheet metal including a contact configured to be electrically connected with the substrate in the second area of the substrate and including an opening provided in a position corresponding to a position where the connecting terminal is provided in the first area.

According to a second aspect of the present disclosure, there is provided an electronic keyboard instrument including the electronic instrument according to the first aspect and a keyboard, wherein the sheet metal fixes the keyboard.

According to a third aspect of the present disclosure, there is provided an electronic apparatus including a substrate including a first area in which a connecting terminal is provided for connection with an external device and a second area which is larger than the first area, a sheet metal including a contact configured to be electrically connected with the substrate in the second area of the substrate and including an opening provided in a position corresponding to a position where the connecting terminal is provided in the first area, and a processor configured to process data which is input from the external device via the connecting terminal.

### BRIEF DESCRIPTION OF THE DRAWINGS

FIG. 1 is a front view of an electronic keyboard instrument according to an embodiment of the present disclosure; the electronic keyboard instrument being supported by an instrument stand;

FIG. 2 is a perspective view of the electronic keyboard instrument according to the embodiment of the present disclosure as viewed from below;

FIG. 3 is a sectional view of the electronic keyboard instrument according to the embodiment of the present disclosure which is taken along a line III-III in FIG. 1;

FIG. 4 is a perspective view of the electronic keyboard instrument according to the embodiment of the present disclosure as viewed from the back with a back plate, an upper surface plate, a keyboard, and the like omitted from illustration;

FIG. 5 is a perspective view of a sheet metal unit with a substrate of the electronic keyboard instrument according to the embodiment of the present disclosure as viewed from the back;

FIG. 6 is a back view of the sheet metal unit with the substrate of the electronic keyboard instrument according to the embodiment of the present disclosure as viewed from a back side;

FIG. 7 is a right side view of the sheet metal unit with the substrate of the electronic keyboard instrument according to the embodiment of the present disclosure;

FIG. 8 is an enlarged front view of a main part of the sheet metal unit with the substrate of the electronic keyboard instrument according to the embodiment of the present disclosure; and

FIG. 9 is an explanatory diagram showing a relationship between the antenna length and the ground in such a state that a wireless dongle is connected to the electronic keyboard instrument according to the embodiment of the present disclosure.

### DESCRIPTION OF THE EMBODIMENT

There is a communication device with a monopole antenna installed for communication between an electronic instrument and a terminal device, and this communication device is used by being connected with electronic instruments of multiple model types.

However, the shape and size of the ground on an electronic instrument vary depending on a model type of an electronic instrument, and as a result, the characteristics of an antenna change for each model type.

In particular, in the case that the size of a substrate constituting a ground of an electronic instrument is small, the performance of an antenna of a communication device deteriorates.

The present disclosure relates to an electronic instrument, an electronic keyboard instrument, and an electronic apparatus with which a communication device can communicate with a good sensitivity.

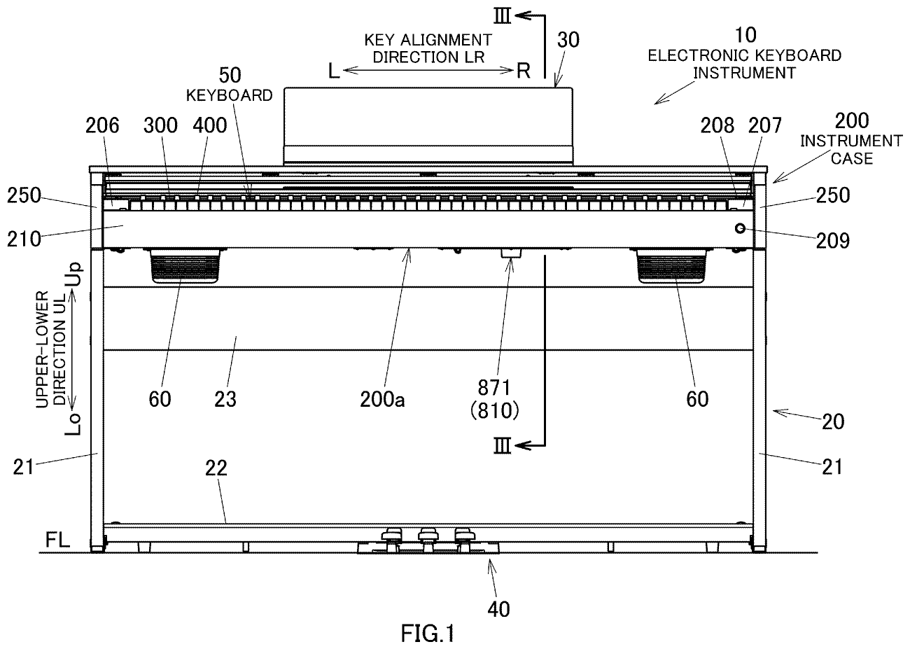

Hereinafter, referring to drawings, an embodiment of the present disclosure will be described. As shown in FIG. 1, an electronic keyboard instrument 10 as an electronic instrument includes in an instrument case 200 a keyboard 50 (also, referred to as a play operation device for designating a pitch of a sound, or an input device) which is provided with multiple keys of full notes (88 notes) including multiple white keys 300 and multiple black keys 400. The electronic keyboard instrument 10 has a music stand 30 which is detachably mounted on the instrument case 200 and is supported by an instrument stand 20 (a leg part).

Here, in the following description, a front of the multiple keys (the white keys 300, the black keys 400) in a front-back direction FB is referred to as a front side F, and a back of the multiple keys in the front-back direction FB is referred to as a back side B. Then, when standing to face the multiple keys, a left is referred to as a left side L, and a right is referred to as a right side R. An alignment direction LR of the multiple keys or a key alignment direction LR is referred to as a left-right direction. In addition, in an upper-lower direction UL of the electronic keyboard instrument 10, an upward direction denotes an upper side Up, while a downward direction denotes a lower side Lo.

As shown in FIGS. 1 to 3, the instrument case 200 includes a front plate 210, a shelf plate 220, a back plate 230, an upper surface plate 240, and left and right side plates 250. The front plate 210 is disposed on a front side F of the keyboard 50. The upper surface plate 240 is disposed on an upper side Up on a back side B of the keyboard 50. The back plate 230 is disposed in such a manner as to connect to a lower surface of the upper surface plate 240 while being held by the left and right side plates 250 therebetween. The shelf plate 220 constitutes a bottom plate of the instrument case 200 (the electronic keyboard instrument 10) and is disposed in such a manner as to be held by the left and right side plates 250 as well as the front plate 210 and the back plate 230.

As shown in FIG. 1, a left wing 206 and a right wing 207, each having substantially a rectangular parallelepiped box shape which is long in the front-back direction FB, are provided on the left side L and the right side R of the keyboard 50, respectively, in such a manner as to be held by the left and right side plates 250 and the keyboard 50. A volume control knob 208 is provided on an upper surface of the right wing 207. In addition, a power supply push-button 209 is provided in the vicinity of a right end of the front plate 210 of the instrument case 200, which will be described later.

The instrument stand 20 has left and right side plates 21. The instrument stand 20 includes a lower beam 22, which is long in the key alignment direction LR and is provided in such a manner as to span the left and right side plates 21 at back lower portions thereof. A pedal device 40 is provided substantially at a central portion of the lower beam 22 in the key alignment direction LR. An upper beam 23 having a plate shape is provided above the lower beam 22. The electronic keyboard instrument 10 is fixed to tops of the left and right side plates 21.

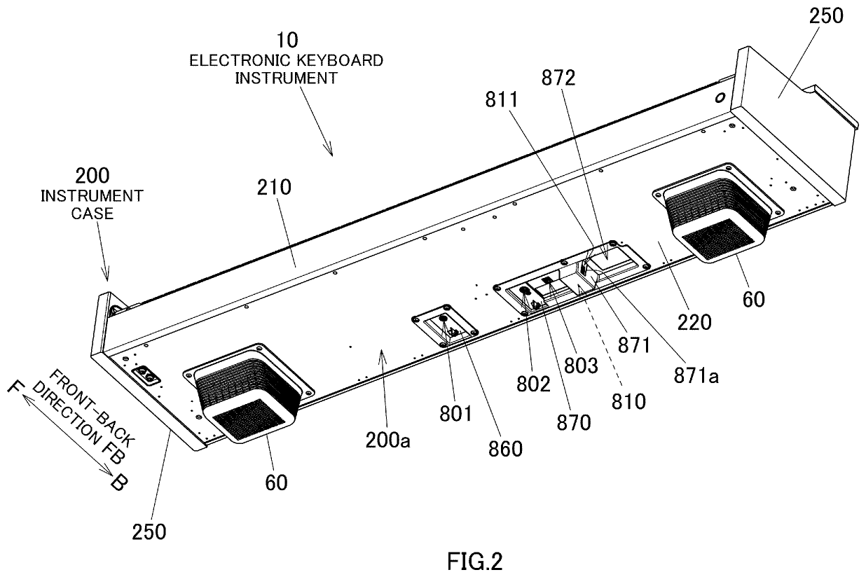

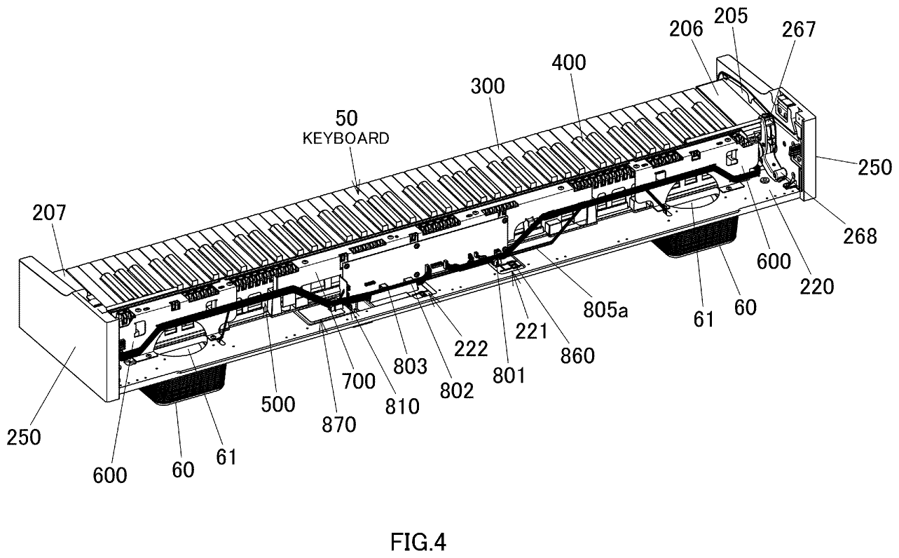

The instrument case 200 of the electronic keyboard instrument 10 is provided in such a manner that a left side surface (an external side surface of the left side plate 250) and a right side surface (an external side surface of the right side plate 250) are contiguous with external surfaces of the left and right side plates 21 of the instrument stand 20. In addition, as shown in FIGS. 1 and 2, loudspeaker covers 60, which protrude downwards, are provided individually leftwards and rightwards on a lower surface 200a of the instrument case 200 in such a manner as to be disposed between the left and right side plates 21. A loudspeaker 61 (refer to FIG. 4) (an output unit for outputting data input from an external device including a wireless dongle 850 via a connecting terminal 810) is provided in an interior of the loudspeaker cover 60. The external device includes a wireless communication device.

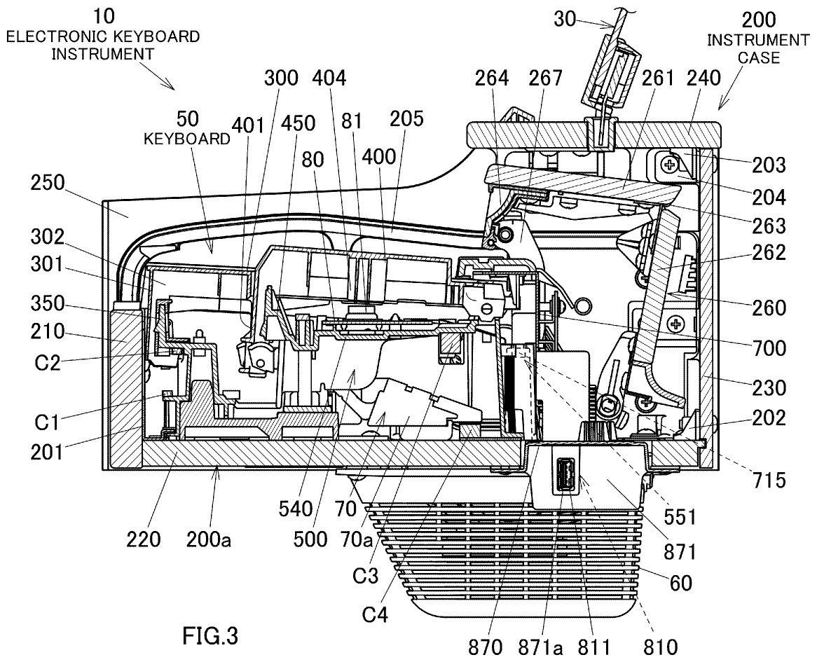

As shown in FIG. 3, the front plate 210 and the shelf plate 220 are connected together with screws by a front connector unit 201. The front connector unit 201 has substantially an L-shape when viewed in the left-right direction and is provided as a sheet metal unit which is long in the left-right direction. The shelf plate 220 and the back plate 230 are connected together with screws by multiple back lower connector units 202, which are a unit having substantially an L-shape and which is aligned with the key alignment direction LR. The back plate 230 and the upper surface plate 240 are connected together with screws by multiple back upper connector units 203, which are a unit having substantially an L-shape and which is aligned with the key alignment direction LR. The left and right side plates 250 and the back plate 230 are connected together with screws by a left back connector unit 204 and a right back connector unit (not shown), which are a sheet metal unit having substantially an L-shape.

A support panel 205 is provided in the vicinity of each of left and right end edges of the shelf plate 220. The left and right support panels 205 are fixed to the shelf plate 220 with screws at lower sides Lo thereof. Then, internal side surfaces of the left and right side plates 250 are fixed to external side surfaces of the left and right support panels 205 with screws, respectively.

The instrument case 200 has a keyboard lid 260, and this keyboard lid 260 is configured to be folded into two portions and constitutes a lid of the keyboard 50. The keyboard lid 260 is made up by connecting a front lid plate 261 and a back lid plate 262, which are two plate-shaped elements elongated in the key alignment direction LR, by a hinge 263. A front lid plate link element 267 and a back lid plate link element 268 (refer to FIG. 4) are provided rotatably on each of the left and right support panels 205 respectively. The front lid plate 261 is connected rotatably to the front lid plate link elements 267 via a drawer unit 264, which is provided at a front end edge of the front lid plate 261 and is elongated in the key alignment direction LR. Similarly, the back lid plate 262 is connected rotatably to the back lid plate link elements 268. The keyboard lid 260 is folded as a result of the front lid plate 261 and the back lid plate 262 being folded along a dividing line which is long in the key alignment direction LR and along which the front lid plate 261 and the back lid plate 262 are connected together with the hinge 263 and is then accommodated in an interior of the instrument case 200 defined below the upper surface plate 240 when the keyboard lid 260 is accommodated. The keyboard lid 260 can cover the keyboard 50 when the keyboard lid 260 is pulled out towards the front side F by hooking the finger or fingers in a concave portion in the drawer unit 264.

A keyboard chassis 500 is provided in the interior of the instrument case 200 in such a manner as to support individually rotatably the white keys 300 and the back keys 400. The white keys 300 are supported rotatably on the keyboard chassis 500 at back ends thereof. The white key 300 includes a sliding rubber 350 which is disposed at a front side F of the keyboard chassis 500, and this sliding rubber 350 is provided between left and right side plates 302 in the vicinity of a front plate 301 of the white key 300 provided at a front end thereof in such a manner as to guide the side plates 302 in the upper-lower direction UL. In addition, a switch pressing portion 304 is provided on the white key 300 in such a manner as to protrude towards the lower side Lo. A switch 81 is disposed on an upper surface of the keyboard chassis 500 in a position corresponding to the switch pressing portion (not shown). The switch 81 is provided on a substrate 80.

A hammer pressing portion (not shown), which is provided between the front plate 301 and the switch pressing portion 304 of the white key 300 in such a manner as to extend towards the lower side Lo, is connected with a hammer 70. The hammer 70 is supported rotatably by a hammer support unit (not shown) provided in an interior of the keyboard chassis 500. The hammer 70 includes a weight element 70a which is disposed on an opposite side to the hammer pressing portion with the hammer support unit held therebetween in the front-back direction FB.

When the white key 300 is pressed down, lower ends of the left and right plates 302 each having a hook-shape descend until the lower ends are brought into abutment with a cushion C1 provided at a front side F of the keyboard chassis 500. As this occurs, the weight element 70a at the back of the hammer 70 rises so as to be brought into abutment with a cushion C3 provided in the interior of the keyboard chassis 500. When the finger is released from the white key 300, the weight element 70a descends so as to be brought into abutment with a cushion C4 provided on the shelf plate 220. As this occurs, jaw portions of the left and right side plates 302 of the white key 300 are brought into abutment with a cushion C2, which is provided on an upper side Up of the cushion C1 in such a manner as to face the cushion C1.

The black key 400 has a similar structure to that of the white key 300. That is, the black key 400 is supported rotatably at a back end by the keyboard chassis 500. The black key 400 has a front plate element 401 having side plates, and the front plate element 401 is guided in the upper-lower direction UL by a sliding rubber 450. In addition, the front plate element 401 is connected to the hammer 70. A switch pressing portion 404 is provided on the black key 400 in such a manner as to press down a switch 81 which is provided for each black key 400.

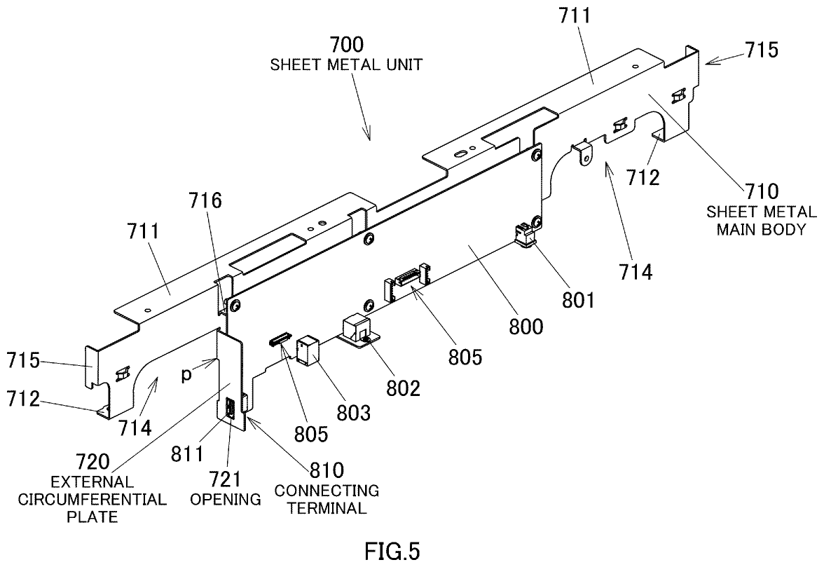

As shown in FIG. 4, three sheet metal units 600, 700 are provided on a back side B of the keyboard chassis 500 provided in the interior of the instrument case 200, and these three sheet metal units 600, 700 are left and right sheet metal units 600, each having substantially the same shape, and a central sheet metal unit 700. The sheet metal units 600, 700 are disposed with their plate surfaces oriented in the front-back direction FB. The central sheet metal unit 700 has portions which are bent to the front side F both on an upper side Up and a lower side Lo thereof and has substantially a U-shape in a side view (refer to FIG. 5). The left and right sheet metal units 600 each have a portion which is bent to the front side F on an upper side Up and a portion which is bent to the back side B on a lower side Lo thereof and each have substantially a crank shape. The left and right sheet metal units 600 have lengths which are substantially identical in the key alignment direction LR, while the central sheet metal unit 700 is provided in such a manner as to have a length which is longer than those of the left and right sheet metal units 600 in the key alignment direction LR.

The left and right sheet metal units 600 are connected to the keyboard chassis 500 with screws at the bent portions on the upper side Up and are fixed to the shelf plate 220 with screws at the bent portions on the lower side Lo. As a result, the keyboard chassis 500 is restricted from moving in the upper-lower direction UL at portions on the back side B of the keyboard chassis 500 by the left and right sheet metal unit 600. Here, the keyboard chassis 500 is restricted from moving in the upper-lower direction UL at portions on a front side F of the keyboard chassis 500 as a result of the keyboard chassis 500 being brought into engagement with the front connector unit 201 (refer to FIG. 3).

As shown in FIG. 5, the central sheet metal unit 700 includes a sheet metal main body 710 which stands erect relative to a setting plane FL (refer to FIG. 1) for the electronic keyboard instrument 10 with front and back surfaces thereof oriented in the front-back direction FB. Multiple cutouts 714 are provided in the sheet metal main body 710 in such a manner that an open side is disposed on a lower side Lo of the sheet metal main body 710. Multiple upper connecting portions 711 and multiple lower connecting portions 712 are provided on the sheet metal unit 700. Specifically, the multiple upper connecting portions 711 are portions on an upper side Up of the sheet metal main body 710 which are bent from the sheet metal main body 710 to the front side F, and the multiple lower connecting portions 712 are portions on a lower side Lo of the sheet metal main body 710 which are bent from the sheet metal main body 710 to the front side F. The upper connecting portions 711 and the lower connecting portions 712 are both connected to the keyboard chassis 500. In addition, although shown at left and right ends of the sheet metal main body 710 in FIG. 5, multiple engagement plates 715 are provided on the sheet metal unit 700 in such a manner as to be bent from the sheet metal main body 710 to the front side F. The engagement plates 715 are individually brought into engagement with engagement holes 551 (refer to FIG. 3) on the back side B of the keyboard chassis 500 to thereby restrict the keyboard chassis 500 from moving in the upper-lower direction UL.

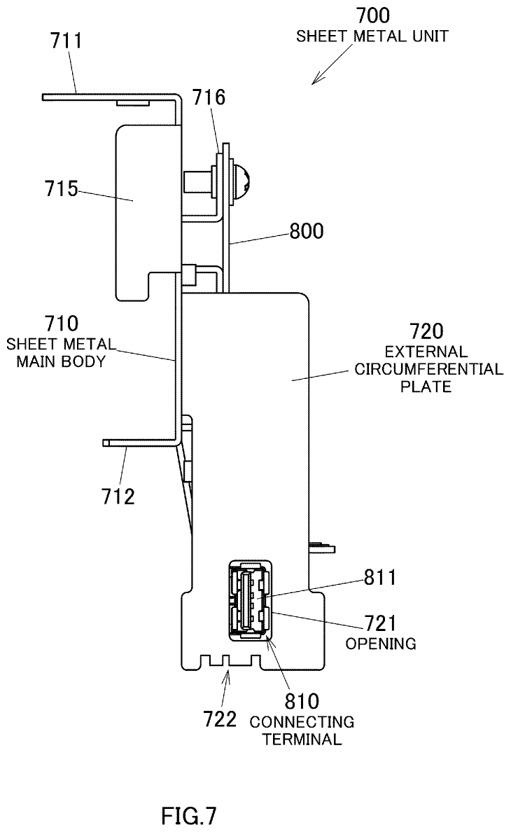

Multiple support stays 716 are provided on the sheet metal main body 710 in such a manner that the multiple support stays 716 stand erect from a back surface of the sheet metal main body 710 to the back side B and are then bent upwards to be shaped substantially into an L-shape in a side view (also, refer to FIG. 7). A substrate 800, having substantially a rectangular shape which is long in the key alignment direction LR, is provided on a back surface side of the sheet metal main body 710 by being screwed down thereto via screw holes in the support stays 716. Multiple connectors 805, to which wiring is connected, are provided on a back surface of the substrate 800.

As a result of being supported by the support stays 716, the substrate 800 is fixedly provided on the sheet metal main body 710 in parallel to the sheet metal main body 710 (in other words, in such a manner as to stand erect relative to the setting plane FL, or in such a manner as to stand erect relative to the shelf plate 220 of the instrument case 200). Here, the connectors 805 are referred to as connector units for wiring 805a which is configured to be connected with substrates provided on the left wing 206 and the right wing 207 of the electronic keyboard instrument 10, as shown in FIG. 4.

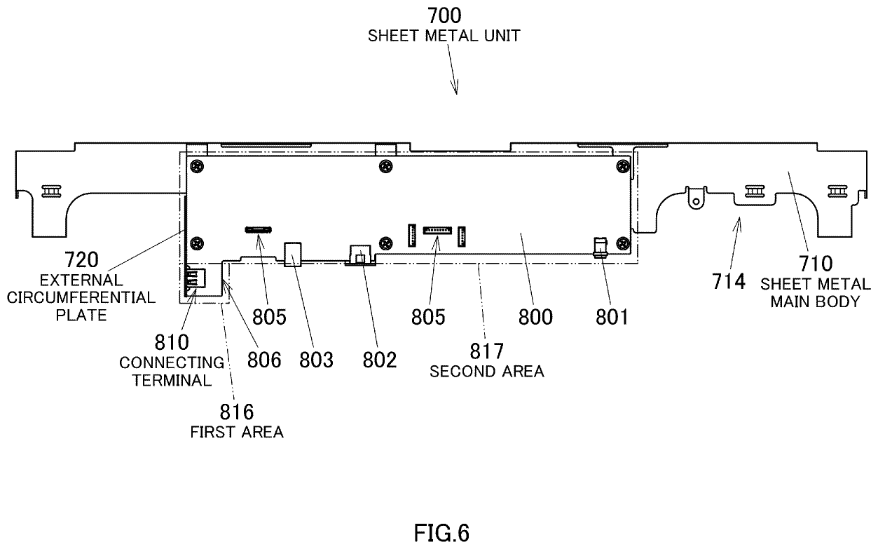

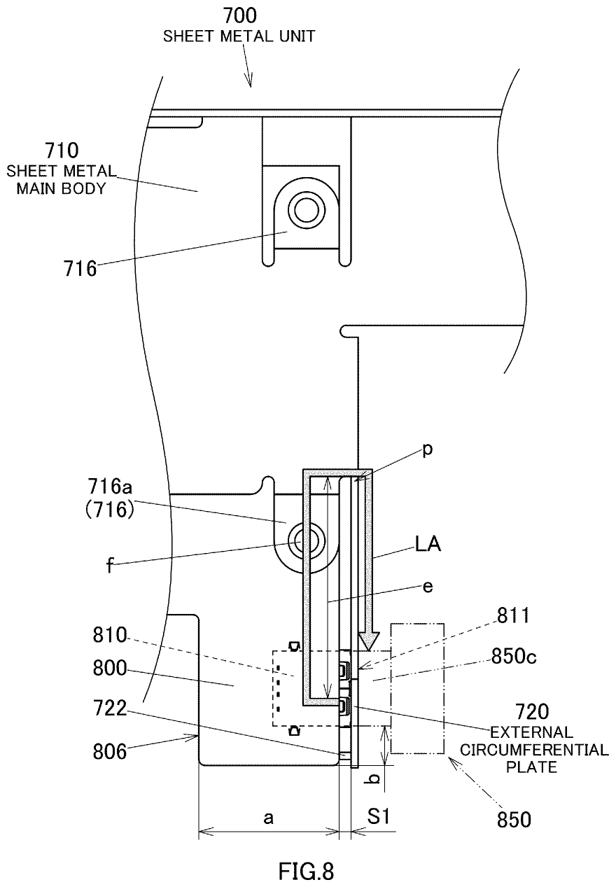

Advantageous effects of the present disclosure will be described. In designing a compact electronic keyboard instrument which is both short in a longitudinal direction and thin in an upper-lower direction of keys, various elaborate designs are necessary for arrangement of internal components. The present embodiment holds the following advantages.
(1) In the present embodiment, the sheet metal unit 700 is provided at the back of the keyboard 50 to fix the keyboard 50 to the instrument case 200. The substrate 800, which includes the various connecting terminals 810, 802 and the like for connection with the external devices, is fixed to the sheet metal unit 700 in such a manner as to stand erect to be substantially perpendicular relative to the setting plane (or the shelf plate 220). As a result, the instrument case can be made thinner in the upper-lower direction UL than a case in which the substrate 800 is disposed in such a manner as to lie in a horizontal direction. In addition, the substrate 800 is disposed nearer to the front side than a backmost end portion of the loudspeaker in the longitudinal direction (the front-back direction FB) of the keys, and as a result, the instrument case can also be made shorter in the longitudinal direction of the keys.
(2) Referring to FIG. 6, the substrate 800 has a first area 816 where the connecting terminal 810, to which the wireless dongle 850 (a communication device, refer to FIG. 8) is connected, is provided and a second area 817 which is larger than the first area 816 on an upper side of the first area 816. As a result, in the present embodiment, the connecting terminal 810 is disposed further downwards than the shelf plate 220 of the instrument case 200. Then, the wireless dongle 850 is inserted into and pulled out of the connecting terminal 810 in the key alignment direction LR by the player on a lower side of the instrument case 220. Since the connecting terminal 810 is provided on the lower side of the instrument case 200 which is hardly visible from the player, the aesthetic appearance of the electronic keyboard instrument 10 is affected little.

A processor is provided in the substrate 800 to process data which is input from external devices including the wireless dongle 850 via the connecting terminal 810.
(3) In executing a communication by connecting the wireless dongle 850 to the connecting terminal 810 provided in the first area 816 of the substrate 800, there is a concern that the performance of the antenna can deteriorate by a relationship between the wavelength of a radio wave and the size of the first area 816 of the substrate 800. To deal with this problem, an antenna current path is formed by electrically coupling the substrate 800 and the sheet metal unit 700 together at a contact f so that an electric field radiated from an antenna element is coupled to an external circumferential plate 720 which is formed by bending the sheet metal unit 700, and the performance of the antenna is improved. Here, the shape of the substrate 800 is assumed to change depending on model types, and hence, the position of the contact f is designed for each model type. As a result, in an electronic apparatus of multiple model types, a good communication can be realized by using the common wireless dongle 850.

Returning to FIG. 5, a power supply terminal 801 is provided at a lower end portion lying in the vicinity of a left end of the substrate 800. An acoustic equipment connecting terminal 802, which is configured to be connected with acoustic equipment, is provided at a portion of the substrate 800 which lies slightly rightwards of a center of the substrate 800 in the key alignment direction LR. A USB-B connecting terminal 803 is provided adjacent to the acoustic equipment connecting terminal 802 in a rightward direction. Here, the USB-B connecting terminal 803 is a terminal for a USB of Type B. A connecting terminal 810 for a USB of Type A is provided at a right end of the substrate 800. The connecting terminal 810 is disposed in such a manner that an insertion port 811 thereof is oriented towards the right side R.

More specifically, as shown in FIG. 8, the connecting terminal 801 is attached to a back surface side of a substrate protruding portion 806 which protrudes substantially into a rectangular shape from a lower side Lo of an end portion on a right side R of the substrate 800. The connecting terminal 810 is attached in such a manner that the insertion port 811 thereof is oriented towards the right side R. In this way, although a detailed description will be made later, in the electronic keyboard instrument 10, the connecting terminal 810 is exposed to an external side of the lower surface 200a of the instrument case 200 while the substrate 800 is accommodated in the instrument case 200. In other words, at least a part of the first area 816 is disposed outside the instrument case 200, and the second area 817 is disposed inside the instrument case 200.

As shown in FIGS. 5 and 7, the external circumferential plate 720, which is coupled to the sheet metal main body 710, is provided on an external circumference of the connecting terminal 810 (an external circumference of the insertion port 811). The external circumferential plate 720 is provided while being bent to protrude from the sheet metal main body 710 to the back side B The external circumferential plate 720 is provided substantially into a rectangular plate shape which is long in the upper-lower direction UL. An opening 721, which has substantially a rectangular shape which is long in the upper-lower direction UL, is provided in the external circumferential plate 720.

The opening 721 is provided in a position which corresponds to the position in the first area 816 where the connecting terminal 810 is provided. Specifically, as shown in FIG. 7, the insertion port 811 of the connecting terminal 810 is disposed within a projection range of the opening 721 in the external circumferential plate 720. In the present embodiment, the insertion port 811 of the connecting terminal 810 (including an external edge of the insertion port 811) is completely accommodated within the projection range of the opening 721. In addition, as shown in FIG. 8, the external circumferential plate 720 is spaced a distance corresponding to a gap S1 apart from the substrate 800. Since the insertion port 811 of the connecting terminal 810 is completely accommodated within the projection range of the opening 721 to such an extent that even the external edge of the insertion port 811 is so accommodated, as shown in FIG. 8, the insertion port 811 is disposed in a position which overlaps a thickness of the external circumferential plate 720 which corresponds to the opening 721. However, the connecting terminal 810 is spaced apart from and hence is not in contact with the external circumferential plate 720.

The contact f is provided at a portion of a support stay 716a lying in the vicinity of the contacting terminal 810 where the substrate 800 is screwed. In other words, the contact f is provided in the second area 817. The contact f electrically connects the substrate 800 having the connecting terminal 810 and the sheet metal unit 700 (the external circumferential plate 720).

A bent portion 722 is provided at a lower end of the external circumferential plate 720 in such a manner as to be bent small from the lower end of the external circumferential plate 720 to the left side L (towards the substrate 800). The bent portion 722 is provided in such a manner as to face the end portion (the end portion on the right side R) of the substrate 800. With the electronic keyboard instrument 10, even though the sheet metal unit 700 and the substrate 800 move relative to each other in a direction in which the gap S1 between the external circumferential plate 720 and the substrate 800 is reduced as a result of an impact or the like being applied thereto, the bent portion 722 is brought into abutment with an end edge of the substrate 800, whereby a distance equal to the gap S1 is secured between the sheet plate unit 700 and the substrate 800. Here, even though the end edge of the substrate 800 is brought into abutment with the bent portion 722, since there is provided no conductive material at the end portion of the substrate 800, there is no risk of the sheet metal unit 700 being brought into electrical contact with the substrate 800.

The wireless dongle 850 is connected to the connecting terminal 810 for a USB of Type A as indicated by a chain double-dashed line in FIG. 8 in addition to a USB memory. As a result of the wireless dongle 850 being connected to the connecting terminal 810, the electronic keyboard instrument 10 can establish a wireless connection with terminal equipment such as a smartphone via the wireless dongle 850. As a result, music data can be transmitted and received between the terminal equipment and the electronic keyboard instrument 10. For example, Bluetooth (Trademark) or BluetoothLow Energy (BLE) according to Version 4 onward of Bluetooth (Trademark) can be used as a predetermined wireless communication mode.

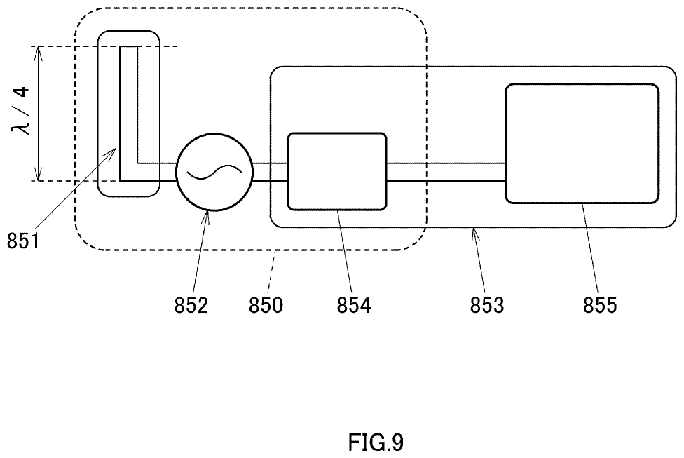

Referring to FIG. 9, the wireless dongle 850 adopts a monopole antenna 851 in order to realize a compact configuration. The monopole antenna 851 is connected with a power supply 852. In addition, the power supply 852 is connected with the ground (GND) 853 which is paired with the monopole antenna 851. Specifically speaking, the ground 853 is made up of the ground (GND) 854 which constitutes the ground of the wireless dongle 850 and the ground (GND) 855 which constitutes the ground of the electronic keyboard instrument 10 with which the ground (GND) 854 is connected.

The monopole antenna 851 is provided as a quarter-wavelength antenna of ¼ wavelengths or λ/4 (λ: a wavelength of a wireless communication). A mirror effect is generated to obtain a good wireless communication state, and therefore, it is necessary that a radius “r” of the ground (GND) 853 is larger than the wavelength of λ/4. In other words, the wireless communication state becomes better as the area of GND 853 becomes wider. Here, since the ground (GND) 854 of the wireless dongle 850 is stationary and the wireless dongle 850 is configured small, the length of the ground (GND) 855 of the electronic keyboard instrument 10 needs to be greater.

For example, in the present embodiment, as shown in FIG. 8, when a length of the substrate protruding portion 806 (the first area) in the key alignment direction LR is referred to as “a”, and a length defined between a lower end of a connecting portion 850c of the wireless dongle 850 and a lower end of the substrate protruding portion 806 is referred to as “b”, let's assume that a=20 mm and b=6.5 mm. In the case of Bluetooth (Trademark) whose frequency is 2.4 GHz, λ=124 mm, that is, λ/4=31 mm. The length of GND 853 (FIG. 9) needs to be greater than λ/4=31 mm in order to obtain a good wireless communication state. However, considering the fact that GND 854 of the wireless dongle 850 is extremely small, GND 855 of the electronic keyboard instrument 10 becomes a+b=26.5 mm, which is insufficient or smaller than the minimum required length of λ/4=31 mm.

Then, in the electronic keyboard instrument 10, the external circumferential plate 720 is provided on the external circumference of the connecting terminal 810 to thereby secure a sufficient ground length. That is, an antenna current path LA indicated by a thick solid line in FIG. 8 starts from the connecting terminal 810, passes through the substrate 800, travels along the external circumferential plate 720 by way of the contact f, and returns to the opening 721, resulting in an extension distance equal to or greater than 2e. Here, a distance e can be referred to as at least a distance from a center of the connecting terminal 810 in the upper-lower direction UL to a lower end p (also, refer to FIG. 5) of a bending portion where the external circumferential plate 720 is bent from the sheet metal main body 710. For example, it is possible to set e=36 mm, and hence, 2e=72 mm, whereby the ground length can be secured which is sufficiently greater than λ/4=31 mm described above.

The acoustic equipment connecting terminal 802, the USB-B connecting terminal 803, and the connecting terminal 810 are exposed from the instrument case 200 as will be described below. As shown in FIGS. 2 and 4, an opening 221, having substantially a rectangular shape which is slightly long in the front-back direction FB, is provided in a portion of the shelf plate 220 which corresponds to the power supply terminal 801. A power terminal cover 860, having substantially a flat plate shape, is provided over the opening 221. The opening 211 is covered with the power supply terminal cover 860. In the power supply terminal 801 whose insertion port is oriented towards the lower side Lo, a circumference surrounding an insertion port of the power supply terminal 801 is provided into a recess which is recessed slightly deeper than the lower surface 200a towards the upper side Up.

An opening 222, having substantially a rectangular shape which is slightly long in the key alignment direction LR, is provided in a portion of the shelf plate 220 which corresponds to the acoustic equipment connecting terminal 802, the USB-B connecting terminal 803, and the connecting terminal 810. A terminal cover 870, having substantially a flat plate shape, is provided over the opening 222. Circumferences surrounding an insertion port of the acoustic equipment connecting terminal 802 and an insertion port of the USB-B connecting terminal 803 are each provided into a recess which is recessed slightly deeper than the lower surface 200a towards the upper side Up. A terminal case 871, which protrudes towards the lower side Lo, is provided on the terminal cover 870 which corresponds to the connecting terminal 810.

The terminal case 871 protrudes substantially into a rectangular parallelepiped shape. The connecting terminal 810 is accommodated in the terminal case 871. An opening 871a is provided in a right side surface of the terminal case 871, whereby the insertion port 811 of the connecting terminal 810 is exposed. In addition, a concave portion 872, which is recessed to the upper side Up, is provided on the terminal cover 870 which lies on a right side R of the terminal case 871.

The power supply terminal 801, the acoustic equipment connecting terminal 802, the USB-B connecting terminal 803, and the connecting terminal 810 are provided between the left and right loudspeaker covers 60 (the loudspeakers 61). The power supply terminal 801, the acoustic equipment connecting terminal 802, the USB-B connecting terminal 803, and the connecting terminal 810 are provided substantially at a central portion in the key alignment direction LR. The connecting terminal 810 protrudes from the lower surface 200a of the instrument case 200 to the lower side Lo.

The connecting terminal 810 includes the insertion port 811 which is disposed in such a manner as to be oriented to the right side R. As a result, an insertion direction of the external device (a USB memory, a communication device (the wireless dongle 850), or the like) into the insertion port 811 constitutes a direction directed from the right side R to the left side L, which is the key alignment direction LR.

Cords are connected to the power supply terminal 801, the acoustic equipment connecting terminal 802, and the USB-B connecting terminal 803. There is almost no risk that these cords come into contact with the legs of the player who plays the electronic keyboard instrument 10 while being seated, causing the player to feel uncomfortable. In addition, also, in the connecting terminal 810 into which the external device is inserted in the key alignment direction LR, the external device protrudes to the right side R, which is the key alignment direction LR, and therefore, there is no such a situation that the external device is installed in a protruding fashion in which the external device protrudes towards the lower side Lo. As a result, a risk of the legs of the player coming into contact with the external device so installed is reduced. Then, as has been described before, a good wireless communication state can be obtained even in such a case that the wireless dongle 850 is attached to the connecting terminal 810.

Thus, as has been described heretofore, according to the embodiment of the present disclosure, the electronic keyboard instrument 10, which constitutes not only an electronic apparatus but also an electronic instrument, includes the substrate 800 including the first area 816 in which the connecting terminal 810 is provided for connection with the external device including the wireless dongle 850 and the second area 817 which is larger than the first area 816, and the sheet metal unit 700, namely a sheet metal including the contact f configured to be electrically connected with the substrate 800 in the second area 817 of the substrate 800 and including the opening 721 provided in the position corresponding to the position where the connecting terminal 810 is provided in the first area 816.

As a result, even in the case that the small wireless dongle 850 (the communication device) as the external device is inserted into the insertion port 811 of the connecting terminal 810 for connection, since a sufficiently large ground is formed for the antenna of the wireless dongle 850, it is possible to provide the electronic keyboard instrument 10 (the electronic instrument, the electronic apparatus) in which the communication device can execute a communication with a good sensitivity.

At least the part of the first area 816 is disposed outside the instrument case 200, and the second area 817 is disposed inside the instrument case 200. As a result, the connecting terminal 810 which is provided on the substrate 800 can be exposed to the outside from the lower surface 200a of the instrument case 200, allowing only the portion where the connecting terminal 810 is provided to protrude from the instrument case 200, while most of the substrate 800 is accommodated within the instrument case 200. Thus, a risk of the connecting terminal 810 coming into contact with the legs of the player who plays the electronic keyboard instrument 10 while being seated can be reduced.

In addition, the sheet metal unit 700 includes the sheet metal main body 710 which fixes the substrate 800 and the external circumferential plate 720 which is coupled to the sheet metal main body 710, and the contact f is provided on the sheet metal main body 710, and the opening 721 is provided in the external circumferential plate 720. As a result, a communication can be executed with a good sensitivity while securely holding the substrate 800 in the interior of the instrument case 200.

The connecting terminal 810 is provided at the central portion in the key alignment direction LR. As a result, a risk of the legs of the player coming into contact with the connecting terminal 810 can be reduced.

The loudspeakers 61 and the loudspeakers covers 60 are provided individually leftwards and rightwards on the lower surface 200a of the instrument case 200, and the connecting terminal 810 is provided between the left and right loudspeakers 61 (the loudspeaker covers 60). As a result, it is possible to provide the connecting terminal 810 which is made to hardly come into contact with the legs of the player who plays the electronic keyboard instrument 10 while being seated, while avoiding a risk of the loudspeaker covers 60, which protrude downwards largely, coming into contact with the legs of the player.

The connecting terminal 810 is disposed in such a manner that the insertion direction is aligned with the key alignment direction LR. Then, the connecting terminal 810 is also disposed in such a manner that the insertion direction is directed from the right side R to the left side L. As a result, the connecting terminal 810 can be disposed in such a manner as to facilitate attachment and detachment of the external device, which is configured to be detachably attached to the connecting terminal 810, by a right-handed person, while reducing a risk of the external device protruding downwards from the lower surface 200a of the instrument case 200.

Here, while the embodiment of the present disclosure has been described heretofore, the embodiment is presented as the example, and hence, there is no intention to limit the scope of the present disclosure by the embodiment. The scope of the present disclosure is not limited to an electronic instrument. The scope of the present disclosure includes an electronic apparatus. The novel embodiment can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of disclosures claimed for patent under claims below and their equivalents.

What is claimed is:

1. An electronic instrument comprising:
a substrate comprising a first area in which a connecting terminal is provided for connection with an external device, and a second area which is larger than the first area; and
a sheet metal comprising a contact configured to be electrically connected with the substrate in the second area of the substrate, and comprising an opening provided in a position corresponding to a position where the connecting terminal is provided in the first area.

2. The electronic instrument according to claim 1,
wherein at least a part of the first area is disposed outside an instrument case, and
wherein the second area is disposed inside the instrument case.

3. The electronic instrument according to claim 1,
wherein the sheet metal comprises a sheet metal main body which fixes the substrate and an external circumferential plate which is coupled to the sheet metal main body,
wherein the contact is provided on the sheet metal main body; and
wherein the opening is provided in the external circumferential plate.

4. The electronic instrument according to claim 1,
wherein the substrate stands erect relative to the setting plane.

5. The electronic instrument according to claim 1,
wherein the external device includes a wireless communication device.

6. An electronic keyboard instrument comprising:
the electronic instrument according to claim 1; and
a keyboard,
wherein the sheet metal fixes the keyboard.

7. The electronic keyboard instrument according to claim 6,
wherein the connecting terminal is provided at a central portion in an alignment direction of a key.

8. The electronic keyboard instrument according to claim 6,
wherein loudspeakers are provided individually leftwards and rightwards on a lower surface of an instrument case, and
wherein the connecting terminal is provided between the loudspeakers provided leftwards and rightwards.

9. The electronic keyboard instrument according to claim 6,
wherein the connecting terminal is disposed in such a manner that an insertion direction is aligned with the alignment direction of the key.

10. An electronic apparatus comprising:
a substrate comprising a first area in which a connecting terminal is provided for connection with an external device, and a second area which is larger than the first area;
a sheet metal comprising a contact configured to be electrically connected with the substrate in the second area of the substrate, and comprising an opening provided in a position corresponding to a position where the connecting terminal is provided in the first area; and
a processor configured to process data which is input from the external device via the connecting terminal.

11. The electronic apparatus according to claim 10, wherein at least a part of the first area is disposed outside a case that accommodates the substrate, and
wherein the second area is disposed inside the case.

12. The electronic apparatus according to claim 10,
wherein the sheet metal comprises a sheet metal main body which fixes the substrate and an external circumferential plate which is coupled to the sheet metal main body,
wherein the contact is provided on the sheet metal main body; and
wherein the opening is provided in the external circumferential plate.

13. The electronic apparatus according to claim 10,
wherein the substrate stands erect relative to the setting plane.

14. The electronic apparatus according to claim 10,
wherein the external device includes a wireless communication device.
